(19) United States
(12) Patent Application Publication
(10) Pub. No.: US 2015/0186649 A1
(43) Pub. Date: Jul. 2, 2015

(54) Function Fingerprinting

(71) Applicant: Cincinnati Bell, Inc., Cincinnati, OH (US)

(72) Inventors: Jeremy Richard Humble, Englewood, OH (US); Cole Michael Robinette, Waynesville, OH (US)

(73) Assignee: CINCINNATI BELL, INC., Cincinnati, OH (US)

(21) Appl. No.: 14/145,041

(22) Filed: Dec. 31, 2013

(51) Int. Cl. G06F 21/56

(52) U.S. Cl. CPC G06F 21/562

(57) ABSTRACT

Systems and methods generate and apply identification codes or “fingerprints” with respect to software functions contained in executable files. Utilizing such fingerprinting procedures, the function identification codes for known malicious files and/or known benign can be stored in the database. Subsequently, received files can be processed in the same manner and the function identification codes generated for the received files can be compared against the function identification codes for the known malicious files and/or known benign files in the database to determine a level of similarity between the functions of received executable files and those of known categorized executable files in the database. This can be used to determine whether a received file is malicious or benign along with a score describing the confidence in that determination.

### FIELD OF THE INVENTION

The current disclosure pertains to systems and methods for detecting and/or identifying software functions in potential malicious executable computer files (i.e., “malware”) on a computer system, or passing through an electronic communication channel such as through email exchanges or through network sensors.

### BACKGROUND OF THE INVENTION

Malicious software, otherwise known as “malware”, presents a serious problem for many types of computer systems. The existence of malware in particular computer systems can interfere with a computer systems' operations, expose or release proprietary information contained in the computer system to third parties or allow third parties to gain unauthorized access to such computer systems. Malware may contain computer viruses, ransom ware, worms, Trojan horses, root kits, key loggers, dialers, spyware, adware and the like. Typical malware products detect issues based on heuristics or signatures—i.e., based on information that can be assessed to be bad. A potential problem with these state of the art products is that if the subject file does not present a specific heuristic or signature attributable to known malware, it is still possible that an executable file may contain other properties, such as malicious software functions, that may be associated with a potential malware threat.

### SUMMARY

The current disclosure provides systems and methods for generating and applying identification codes or “fingerprints” onto software functions contained in executable files. Utilizing such fingerprinting procedures, the function identification codes for known malicious files and/or known benign files can be stored in the database. Subsequently, received files can be processed in the same manner and the function identification codes generated for the received files can be compared against the function identification codes for the known malicious files and/or benign in the database to determine a level of similarity between the functions of received executable files and those of known categorized executable files in the database. This can be used to determine whether the received file is malicious or benign, optionally along with a score describing the confidence in that determination. Further, the system can use specific known bad function identification codes as signatures, alerting when a received file matches one of the known bad function identification codes.

An aspect of the current disclosure provides a system for executable file identification, that may include: (A) database(s) containing function identification codes for a respective plurality of known executable files, where each function identification code corresponds to a software function contained in the respective known executable file; and (B) at least one computer, having access to the database(s), and being programmed to perform the steps of: receiving an executable file; generating a function identification code for software function(s) contained in the received executable file, comparing function identification codes generated for the received file against function identification codes for the plurality of known executable files in the database(s) to determine a level of similarity between a software function contained in the received executable file and a software function contained in a known executable file. In a more detailed embodiment, the step of generating a function identification code for software function(s) contained in the received executable file may include the following steps: disassembling the executable file into assembly code instructions; and breaking the disassembled assembly code instructions into one or more software functions. In a further detailed embodiment, the step of generating a function identification code for software function(s) contained in the received executable file is based upon the identification of assembly language operations (e.g., opcodes) respectively contained in each of the software function(s).

Alternatively, or in addition, the step of generating a function identification code for software function(s) contained in the received executable file may be based upon the types of assembly language operations (e.g., opcodes) respectively contained in each of the software function(s). In a further detailed embodiment, the step of generating a function identification code for software function(s) contained in the received executable file may remove or otherwise disregard (i.e., ignore) the operands and arguments associated with the assembly language operations (e.g., opcodes) in the assembly code instructions. In a further detailed embodiment, each type of assembly language operation is associated with an alphanumeric character, and the step of generating a function identification code for software function(s) contained in the received executable file includes building a string of the alphanumeric characters sequentially associated with the types of assembly language operations respectively contained in each of the software function(s). In a further detailed embodiment, the comparing step may utilize string similarity algorithms.

In an alternate detailed embodiment, the known executable files contain known malicious executable files, and the comparing step may compare function identification codes generated for the received file against function identification codes for the plurality of known malicious executable files in the database(s) to determine a level of similarity between the received executable file and one or more of the known malicious executable files in the database(s). In a further detailed embodiment, the known executable files contain known malicious executable files and known benign executable files, and the comparing step may compare function identification codes generated for the received file against function identification codes for the plurality of known malicious executable files and known benign executable files in the database(s) to determine a level of similarity between the received executable file and one or more of the known malicious executable files and known benign executable files in the database(s).

It is another aspect of the current disclosure to provide a system for identifying whether an executable file may be a malicious executable file that includes: (A) database(s) containing function identification codes for a respective plurality of known executable malicious files, each function identification code corresponding to a software function contained in the respective known executable malicious file; (B) at least one computer, having access to the database(s), and being programmed to perform the steps of: receiving an executable file; disassembling the received file into assembly code instructions; breaking the disassembled assembly code instructions into functional groups; simplifying operations of the assembly code instructions into operation types; for each functional group, sequentially labeling each operation type in the functional group with an alphanumeric character and building an alpha numeric string based upon the sequence of such alphanumeric characters; for each functional group, generating an associated function identification code from the alpha numeric string built for such functional group, and comparing function identification codes generated for the received file against function identification codes for the plurality of known executable malicious files in the database(s) to determine a level of similarity between the received executable file and one or more of the known executable malicious files in the database(s). In a detailed embodiment, the functional groups may correspond to identified individual software functions. In a further detailed embodiment, the operation types may include operations simplified to a basic category of operations. In a further detailed embodiment, the operation types may include an operation type for a plurality of different move operations; an operation type for a plurality of different jump operations; an operation type for a plurality of different push operations; an operation type for a plurality of different conditional jump operations; and/or an operation type for a plurality of different call operations. Alternatively or in addition, the simplifying step may include a step of ignoring (disregarding or removing) arguments and operands.

It is another aspect of the current disclosure to provide any method or steps as discussed herein. It is another aspect of the current disclosure to provide a non-transitory memory device including computer instructions for instructing a computer system to perform the steps of any of the methods or processes described herein.

These and other aspects of the current disclosure will be apparent in light of the following Detailed Description, the appended claims and the attached drawings.

### BRIEF DESCRIPTION OF THE DRAWINGS

FIG. 1 provides a block diagram representation of a computing environment for use with the embodiments of the current disclosure;

FIG. 2 presents a flow diagram for an exemplary process for generating function identification codes for software functions in a received executable file; and

FIG. 3 provides a block diagram illustration of some of the exemplary processing steps discussed in FIG. 2.

### DETAILED DESCRIPTION

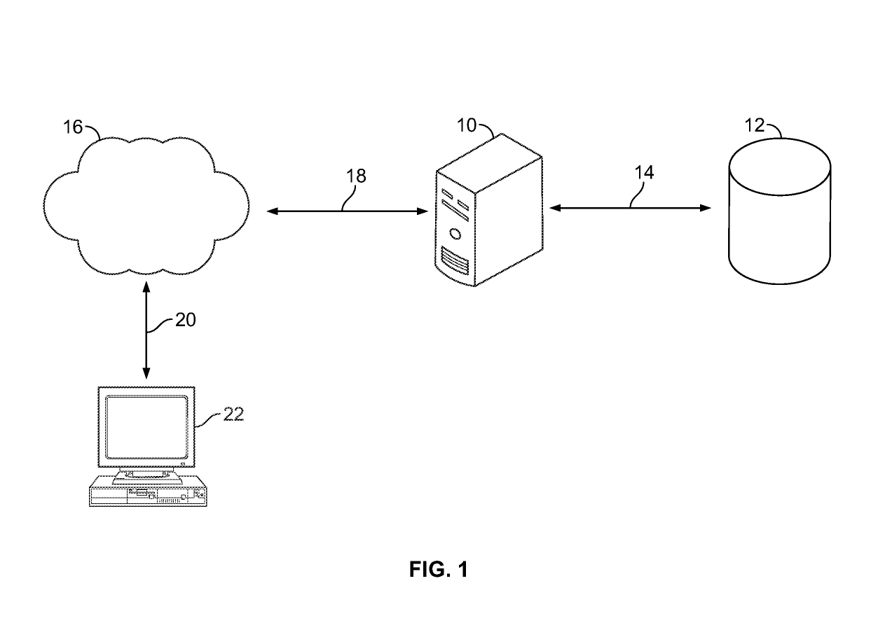

FIG. 1 provides a very basic computing environment which may be used with the embodiments of the current disclosure. The example computing environment may include a computer server 10 (or a plurality of computer servers) coupled to a database 12 (or a plurality of databases) by a datalink 14 and coupled to a computer network (such as the internet) 16 by a datalink 18. Also coupled to the computer network 16 by a datalink 20 is a user computer terminal 22. The database 12 may include function identification codes for functions contained in known malicious files (and, in some embodiments, known benign files), and may also contain associations between the function identification codes, the functions and the known files. In an embodiment, the function identification codes may be in the form of an ASCII string, such as a base64 string, and may describe a function in a position independent way.

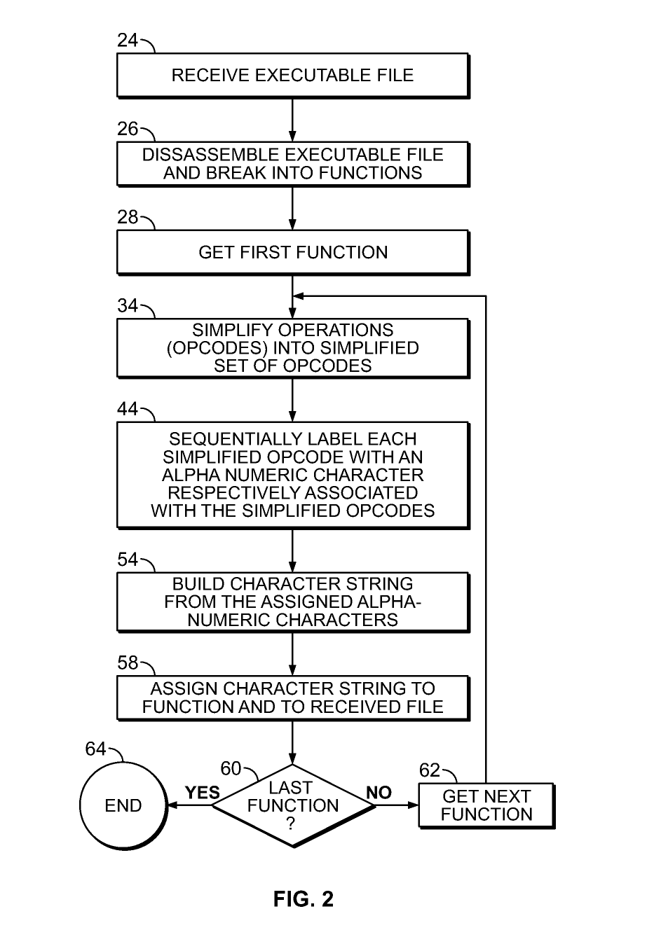

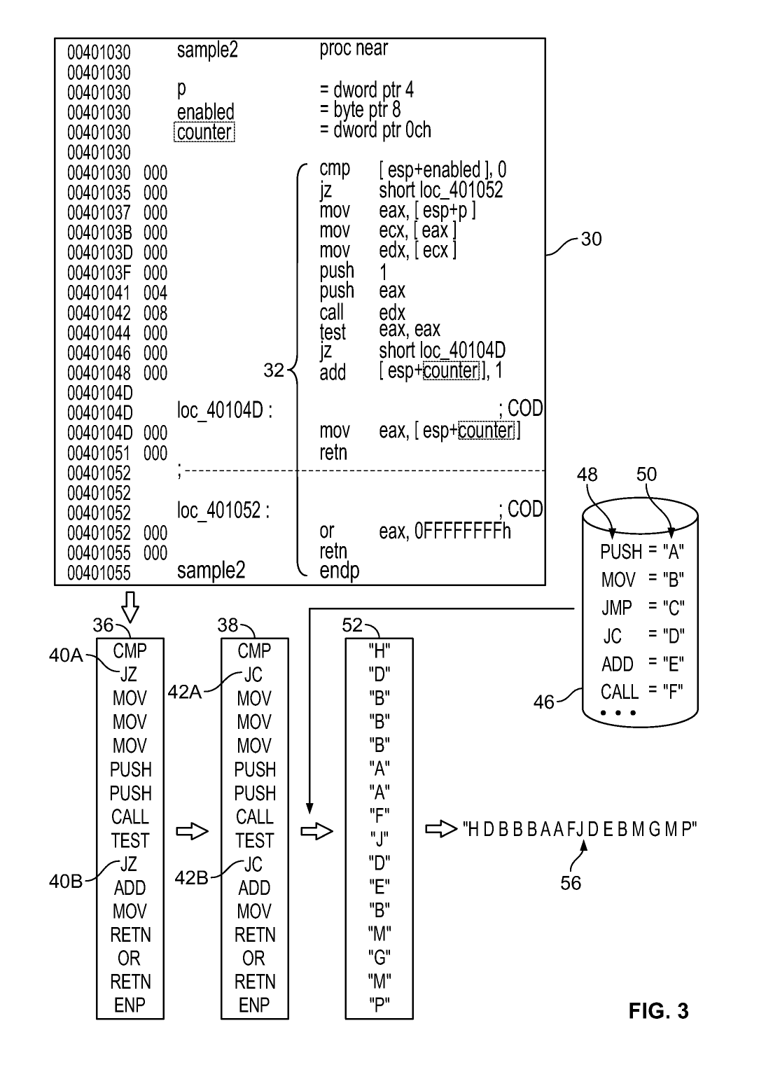

As shown in FIG. 2 and FIG. 3, an exemplary process for generating function identification codes for functions contained in executable files (or “function fingerprints”) is provided. In a first step 24 an executable file is received. Moving onto step 26, the executable file may be disassembled by a disassembler tool into assembly code instructions. This disassembly tool may also be capable of breaking up the disassembled assembly code instructions into individual software functions (e.g., software subroutines and other identifiable software functions). Examples of disassemblers that have this disassemble and function breaking capabilities include IDA and RoseCC disassemblers. Moving onto step 28 the process may next attain a first function provided by the disassembler.

As shown FIG. 3, an example function 30 is depicted. As can be seen, the example function includes a plurality of assembly code instructions 32 where each of the assembly code instructions include operators such as “cmp”, “jz” and mov” and each of the assembly code instructions also include operands or arguments associated with the assembly code instructions.

Referring back to FIG. 2, a next step 34 is to simplify the assembly codes operators (or opcodes) from the assembly code instructions into a simplified set of opcodes. To do this, in an embodiment, as shown in the FIG. 3 example, the operands or arguments, are stripped from the operators to provide a set of operators/opcodes 36 without the operands or arguments. Next, the operators/opcodes are simplified into a simplified set of opcodes 38. The simplification step may involve representing, for example, all of the same types or classes of opcodes as a single opcode. For example, all of the conditional jumps such as “jne”, “jz”, “jzce” can be all represented by a single verb or opcode such as “jc” (which may stand for conditional jump). For example, as shown in FIG. 3, the two conditional jumps “jz” 40A and “jz” 40B have been simplified into simplified opcodes “jc” 42A and “jc” 42B. Other examples of simplification of opcodes could be, for example, to simplify all move instructions such as “movsx” (move with sign extended) or “movzx” (move with zero extended) into a simplified single opcode such as “mov”. The above examples are just a couple examples of simplifying classes of opcodes into a single simplified opcode. Many more types of simplifications can be performed as a person of ordinary skill would be aware. In an embodiment, the simplification process may able to simplify the 1000+ x86 instruction set, for example, down to 30-50 simplified opcodes.

Referring back to FIG. 2, a next step 44 may be to sequentially label each simplified opcode with an alphanumeric character respectively associated with the simplified opcodes. Referring to the FIG. 3 example, a data structure 46 may include a table associating the simplified opcodes 48 with unique alphanumeric characters 50. For example, the “push” opcode is associated in this example with the alphanumeric character “A”; the “mov” opcode is associated in this table with the alphanumeric character “B” and the “jmp” opcode in this example is associated with the alphanumeric character “C”, and so on. Using this table, each of the simplified opcodes in the opcode set 38 may labeled with the respective alphanumeric character from the data structure 46 to provide a set of alphanumeric characters 52 for the associated opcodes in the specific function.

Referring back to FIG. 2, a next step 54 may be to build a character string from the assigned alphanumeric characters. As shown in the FIG. 3 example, the character string 56 is built from the alphanumeric set 52. Referring back to FIG. 2, a next step 58 may be to assign that character string to the function 30 and/or to the received executable file, and then storing the function identification code and the function and received file in the database 12. The next step 60 may be to check if the current function is the last function. If not, the next function is obtained in step 62 and the process returns to step 34. If the current function is the last function in step 60, the process of generating identification codes for software functions ends at step 64.

By using this exemplary process, identification codes can be generated for functions in known executable files, such as known malicious files and known benign files and those function identification codes and file associations can be stored in the database 12. Subsequently, when a new unknown file is received, a process for generating function identification codes can be performed on the new unknown file; subsequently, the function identification codes in the unknown file can be compared with the function identification codes in the database with respect to the known files to determine a level of similarity between the unknown executable file and any one or more of the known executable files in the database 12. This comparison can be performed utilizing string similarity algorithms (such as Hamming distance, the Damerau-Levenshtein distance, Jaro-Winkler distance, etc.) as known to those of ordinary skill.

Utilizing the above exemplary process, the function identification codes may look something like a base64 string and describes a function in a position independent way. Because the exemplary process removes or disregards (i.e., ignores) operands and arguments, changes like different absolute value addresses, use of different general registers, etc., may not impact the resulting function identification code (fingerprint), which may increase the chance of matching the same function compiled into different executables. These function identification codes can be used as tags with respect to the malware detection and identification system and methods as described in U.S. patent application Ser. No. 14/107,605, filed Dec. 16, 2013, the disclosure of which is incorporated herein by reference.

To provide additional context for various aspects of the current disclosure, the following discussion is intended to provide a brief, general description of a suitable computing environment in which the various aspects of the current disclosure may be implemented. While example embodiments of the current disclosure relate to the general context of computer-executable instructions that may run on one or more computers (e.g., computers 10 and/or 22), those skilled in the art will recognize that the embodiments also may be implemented in combination with other program modules and/or as a combination of hardware and software.

Generally, program modules include routines, programs, components, data structures, etc., that perform particular tasks or implement particular abstract data types. Moreover, those skilled in the art will appreciate that aspects of the inventive methods may be practiced with other computer system configurations, including single-processor or multiprocessor computer systems, minicomputers, mainframe computers, as well as personal computers, hand-held wireless computing devices, microprocessor-based or programmable consumer electronics, and the like, each of which can be operatively coupled to one or more associated devices. Aspects of the current disclosure may also be practiced in distributed computing environments where certain tasks are performed by remote processing devices that are linked through a communications network. In a distributed computing environment, program modules may be located in both local and remote memory storage devices.

A computer may include a variety of computer readable media. Computer readable media may be any available media that can be accessed by the computer and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media (i.e., non-transitory computer readable media) includes, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which may be used to store the desired information and which may be accessed by the computer.

An exemplary environment for implementing various aspects of the current disclosure may include a computer that includes a processing unit, a system memory and a system bus. The system bus couples system components including, but not limited to, the system memory to the processing unit. The processing unit may be any of various commercially available processors. Dual microprocessors and other multi-processor architectures may also be employed as the processing unit.

The system bus may be any of several types of bus structure that may further interconnect to a memory bus (with or without a memory controller), a peripheral bus, and a local bus using any of a variety of commercially available bus architectures. The system memory may include read only memory (ROM) and/or random access memory (RAM). A basic input/output system (BIOS) is stored in a non-volatile memory such as ROM, EPROM, EEPROM, which BIOS contains the basic routines that help to transfer information between elements within the computer, such as during start-up. The RAM may also include a high-speed RAM such as static RAM for caching data.

The computer may further include an internal hard disk drive (HDD) (e.g., EIDE, SATA), which internal hard disk drive may also be configured for external use in a suitable chassis, a magnetic floppy disk drive (FDD), (e.g., to read from or write to a removable diskette) and an optical disk drive, (e.g., reading a CD-ROM disk or, to read from or write to other high capacity optical media such as the DVD). The hard disk drive, magnetic disk drive and optical disk drive may be connected to the system bus by a hard disk drive interface, a magnetic disk drive interface and an optical drive interface, respectively. The interface for external drive implementations includes at least one or both of Universal Serial Bus (USB) and IEEE 1394 interface technologies.

The drives and their associated computer-readable media may provide nonvolatile storage of data, data structures, computer-executable instructions, and so forth. For the computer, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the current disclosure.

A number of program modules may be stored in the drives and RAM, including an operating system, one or more application programs, other program modules and program data. All or portions of the operating system, applications, modules, and/or data may also be cached in the RAM. It is appreciated that the invention may be implemented with various commercially available operating systems or combinations of operating systems.

It is within the scope of the disclosure that a user may enter commands and information into the computer through one or more wired/wireless input devices, for example, a touch screen display, a keyboard and/or a pointing device, such as a mouse. Other input devices may include a microphone (functioning in association with appropriate language processing/recognition software as known to those of ordinary skill in the technology), an IR remote control, a joystick, a game pad, a stylus pen, or the like. These and other input devices are often connected to the processing unit through an input device interface that is coupled to the system bus, but may be connected by other interfaces, such as a parallel port, an IEEE 1394 serial port, a game port, a USB port, an IR interface, etc.

A display monitor or other type of display device may also be connected to the system bus via an interface, such as a video adapter. In addition to the monitor, a computer may include other peripheral output devices, such as speakers, printers, etc.

The computer may operate in a networked environment using logical connections via wired and/or wireless communications or data links to one or more remote computers. The remote computer(s) 22 may be a workstation, a server computer, a router, a personal computer, a portable computer, a personal digital assistant, a cellular device, a microprocessor-based entertainment appliance, a peer device or other common network node, and may include many or all of the elements described relative to the computer. The logical connections or data links (14, 18, 20) depicted could include wired/wireless connectivity to a local area network (LAN) and/or larger networks, for example, a wide area network (WAN). Such LAN and WAN networking environments are commonplace in offices, and companies, and facilitate enterprise-wide computer networks, such as intranets, all of which may connect to a global communications network such as the Internet. For the purposes of the current disclosure a data link between two components may be any wired or wireless mechanism, medium, system and/or protocol between the two components, whether direct or indirect, that allows the two components to send and/or received data with each other.

The computer may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi (such as IEEE 802.11x (a, b, g, n, etc.)) and Bluetooth™ wireless technologies. Thus, the communication may be a predefined structure as with a conventional network or simply an ad hoc communication between at least two devices.

The system may also include one or more server(s) 10. The server(s) may also be hardware and/or software (e.g., threads, processes, computing devices). The servers may house threads to perform transformations by employing aspects of the invention, for example. One possible communication between a client and a server may be in the form of a data packet adapted to be transmitted between two or more computer processes. The data packet may include a cookie and/or associated contextual information, for example. The system may include a communication framework (e.g., a global communication network such as the Internet) that may be employed to facilitate communications between the client(s) and the server(s).

For the purposes of the current disclosure a “database” is any organized collection of data in electronic form (e.g., accessible by a computer), set up in a manner so that computer(s) can access the data stored in the database through appropriate operation of computer software.

Following from the above description and summaries, it should be apparent to those of ordinary skill in the art that, while the methods, apparatuses and data structures herein described constitute exemplary embodiments of the current disclosure, it is to be understood that the inventions contained herein are not limited to the above precise embodiments and that changes may be made without departing from the scope of the inventions as claimed. For example, it is not necessary that the exact form of the many-to-many database structure 36 illustrated and discussed herein be utilized to fall within the scope of the claims, since the described and illustrated many-to-many database structure 36 is merely a single example of numerous many-to-many data structures that could satisfy the functionality described herein for such structure. As another example, is not necessary that the exact form of the tag record structure 24 described and illustrated herein be utilized to fall within the scope of the claims, since the described and illustrated tag record structure 24 is merely a single example of numerous data structures for containing tag data to satisfy the functionality described herein for such structure.

Following from the above description summaries, it should be apparent to those of ordinary skill in the art that, while the methods, apparatuses and data structures herein described constitute exemplary embodiments of the current disclosure, it is to be understood that the inventions contained herein are not limited to the above precise embodiments and that changes may be made without departing from the scope of the invention as claimed. Likewise it is to be understood that it is not necessary to meet any or all of the identified advantages or objects of the invention disclosed herein in order to fall within the scope of the inventions, since inherent and/or unforeseen advantages of the current disclosed embodiments may exist even though they may not have been explicitly discussed herein.

What is claimed is:

1. A system for executable file identification, comprising:
(A) one or more databases containing one or more function identification codes for a respective plurality of known executable files, each function identification code corresponding to a software function contained in the respective known executable file; and
(B) at least one computer, having access to the database, and being programmed to perform the steps of:
receiving an executable file,
generating a function identification code for one or more software functions contained in the received executable file, and
comparing a function identification code generated for the received file against function identification codes for the plurality of known executable files in the one or more databases to determine a level of similarity between a software function contained in the received executable file and a software function contained in a known executable file.

2. The system of claim 1, wherein the step of generating a function identification code for one or more software functions contained in the received executable file includes the following steps:
disassembling the executable file into assembly code instructions; and
breaking the disassembled assembly code instructions into one or more software functions.

3. The system of claim 2, wherein the step of generating a function identification code for one or more software functions contained in the received executable file is based upon the identification of assembly language opcodes respectively contained in each of the one or more software functions.

4. The system of claim 2, wherein the step of generating a function identification code for one or more software functions contained in the received executable file is based upon the types of assembly language opcodes respectively contained in each of the one or more software functions.

5. The system of claim 4, wherein the step of generating a function identification code for one or more software functions contained in the received executable file ignores the operands and arguments associated with the assembly language opcodes in the assembly code instructions.

6. The system of claim 5, wherein each type of assembly language opcode is associated with an alphanumeric character, and the step of generating a function identification code for one or more software functions contained in the received executable file includes building a string of the alphanumeric characters sequentially associated with the types of assembly language opcodes respectively contained in each of the one or more software functions.

7. The system of claim 4, wherein each type of assembly language opcode is associated with an alphanumeric character, and the step of generating a function identification code for one or more software functions contained in the received executable file includes building a string of the alphanumeric characters sequentially associated with the types of assembly language operations respectively contained in each of the one or more software functions.

8. The system of claim 7, wherein the comparing step utilized string similarity algorithms.

9. The system of claim 4, wherein the step of generating a function identification code for one or more software functions contained in the received file includes simplifying classes of the same types of opcodes into a respective simplified opcode.

10. The system of claim 9, wherein the step of simplifying classes of the same types of opcodes includes simplifying a plurality of different jump instructions into a single opcode.

11. The system of claim 9, wherein the step of simplifying classes of the same types of opcodes includes simplifying a plurality of different move instructions into a single opcode.

12. The system of claim 1, wherein the known executable files contain known malicious executable files, and the comparing step compares function identification codes generated for the received file against function identification codes associated with the plurality of known malicious executable files in the one or more databases to determine a level of similarity between the received executable file and one or more of the known malicious executable files in the one or more databases.

13. The system of claim 12, wherein the known executable files contain known malicious executable files and known benign executable files, and the comparing step compares function identification codes generated for the received file against function identification codes associated with the plurality of known malicious executable files and known benign executable files in the one or more databases to determine a level of similarity between the received executable file and one or more of the known malicious executable files and known benign executable files in the one or more databases.

14. The system of claim 1, wherein the comparing step utilizes string similarity algorithms.

15. A system for identifying whether an executable file may be a malicious executable file, comprising:
(A) one or more databases containing one or more function identification codes for a respective plurality of known executable malicious files, each function identification code corresponding to a software function contained in the respective known executable malicious file; and
(B) at least one computer, having access to the database, and being programmed to perform the steps of:
receiving an executable file,
disassembling the received file into assembly code instructions,
breaking the disassembled assembly code instructions into functional groups,
simplifying operations of the assembly code instructions into operation types;
for each functional group, sequentially labeling each operation type in the functional group with an alphanumeric character and building an alpha numeric string based upon the sequence of such alphanumeric characters,
for each functional group, generating an associated function identification code from the alpha numeric string built for such functional group, and
comparing function identification codes generated for the received file against function identification codes for the plurality of known executable malicious files in the one or more databases to determine a level of similarity between the received executable file and one or more of the known executable malicious files in the one or more databases.

16. The system of claim 15, wherein the functional groups correspond to identified individual software functions.

17. The system of claim 15, wherein the operation types include operations simplified to a basic category of operations.

18. The system of claim 17, wherein the operation types includes one or more of:
an operation type for a plurality of different move operations;
an operation type for a plurality of different jump operations;
an operation type for a plurality of different push operations;
an operation type for a plurality of different conditional jump operations; and
an operation type for a plurality of different call operations.

19. The system of claim 15, wherein the simplifying step includes a step of ignoring arguments and operands.

20. One or more non-transitory memory components containing computer instructions for instructing a computer system to perform the steps of:
receiving an executable file,
generating a function identification code for one or more software functions contained in the received executable file, and
comparing a function identification code generated for the received file against function identification codes for a plurality of known executable files in one or more databases accessible by the computer system to determine a level of similarity between a software function contained in the received executable file and a software function contained in a known executable file.

21. The one or more non-transitory memory components of claim 20, wherein the step of generating a function identification code for one or more software functions contained in the received executable file includes the following steps:
disassembling the executable file into assembly code instructions; and
breaking the disassembled assembly code instructions into one or more software functions.

22. The one or more non-transitory memory components of claim 20, wherein the step of generating a function identification code for one or more software functions contained in the received executable file is based upon the identification of assembly language opcodes respectively contained in each of the one or more software functions.

23. The one or more non-transitory memory components of claim 21, wherein the step of generating a function identification code for one or more software functions contained in the received executable file is based upon the types of assembly language opcodes respectively contained in each of the one or more software functions.

24. The one or more non-transitory memory components of claim 23, wherein the step of generating a function identification code for one or more software functions contained in the received executable file ignores the operands and arguments associated with the assembly language opcodes in the assembly code instructions.

25. The one or more non-transitory memory components of claim 24, wherein each type of assembly language opcode is associated with an alphanumeric character, and the step of generating a function identification code for one or more software functions contained in the received executable file includes building a string of the alphanumeric characters sequentially associated with the types of assembly language opcodes respectively contained in each of the one or more software functions.

26. The one or more non-transitory memory components of claim 20, wherein the known executable files contain known malicious executable files, and the comparing step compares function identification codes generated for the received file against function identification codes associated with the plurality of known malicious executable files in the one or more databases to determine a level of similarity between the received executable file and one or more of the known malicious executable files in the one or more databases.

27. The one or more non-transitory memory components of claim 20, wherein the comparing step utilizes string similarity algorithms.
